(19) United States
(12) Patent Application Publication
(10) Pub. No.: US 2023/0268529 A1
(43) Pub. Date: Aug. 24, 2023

(54) FUEL CELL VEHICLE AND DETECTION SYSTEM FOR DETECTING HYDROGEN IN A FUEL CELL VEHICLE

(71) Applicant: Robert Bosch GmbH, Stuttgart (DE)

(72) Inventors: Timo Bosch, Renningen (DE); Tobias Falkenau, Esslingen (DE)

(21) Appl. No.: 18/006,782

(22) PCT Filed: Jul. 15, 2021
(86) PCT No.: PCT/EP2021/069805

§ 371 Date: Jan. 25, 2023

(30) Foreign Application Priority Data
Jul. 28, 2020 (DE) 10 2020 209 494.2

(51) Int. Cl. H01M 8/0444; H01M 8/04223; B60L 50/72; B60L 3/00

(52) U.S. Cl. CPC H01M 8/04447; H01M 8/04231; B60L 50/72; B60L 3/0053; H01M 2250/20; H01M 2008/1095

(57) ABSTRACT

The invention relates to a detection system (10a; 10b; 10c) for detecting hydrogen (11) in a cavity (12) of a fuel cell vehicle (13), comprising a fuel cell system (15) with a fuel cell housing (16) and a purging air line (17) for purging the fuel cell housing (16) and a hydrogen sensor (14) outside the fuel cell housing (16), wherein the purging air line (17) has a purging air outlet (18) for discharging purging air (19) out of the fuel cell housing (16), wherein the purging air outlet (18) is designed for applying the hydrogen sensor (14) with the purging air from the purging air line (17). The invention also relates to a fuel cell vehicle (13) comprising a detection system (10a; 10b; 10c) according to the invention.

### BACKGROUND

The present invention relates to a detection system for detecting hydrogen in a cavity of a fuel cell vehicle, comprising a fuel cell system with a fuel cell housing and a purging air line for purging the fuel cell housing and a hydrogen sensor outside the fuel cell housing, wherein the purging air line has a purging air outlet for discharging purging air out of the fuel cell housing. The invention further relates to a fuel cell vehicle comprising such a detection system.

In polymer electrolyte membrane (PEM) fuel cell systems, hydrogen is converted into electrical energy using oxygen while generating waste heat and water. For this purpose, such a PEM fuel cell system generally has a plurality of stacked fuel cells, each with an anode that is in each case supplied with hydrogen, a cathode that is in each case supplied with air and polymer electrolyte membranes that are in each case placed between an anode and a cathode. By stacking the fuel cells, the electrical output voltage of the fuel cell system can be increased. Within such a stack, there are supply channels that supply the individual fuel cells with hydrogen and air, or remove depleted moist air and depleted anode exhaust gas from the fuel cell stack, or the fuel cell system. Structurally, a fuel cell stack has many meters of sealing points through which small amounts of hydrogen can leave the fuel cell stack in the form of leakage.

For the defined removal of the escaping hydrogen, the fuel cell stack in accordance with the prior art is enclosed by a fuel cell housing. The fuel cell housing is supplied with purging air in a defined manner from at least one point. At at least one further point, the purging air leaves the fuel cell housing again through a purging air line. The fuel cell housing is purged, as it were, with the purging air. With fuel cell systems of this type, a hydrogen sensor is installed in or on the purging air line in order to detect hydrogen in the fuel cell housing. In addition, according to statutory requirements, a further hydrogen sensor must be installed in closed or semi-closed cavities, such as in an engine compartment of the fuel cell vehicle. With known systems, both hydrogen sensors detect hydrogen, or a hydrogen concentration, and cause the fuel cell system to shut down when it is detected that a predefined limit is exceeded. However, hydrogen sensors are expensive and lead to a complex system structure in the fuel cell vehicle.

### SUMMARY

The present invention proposes a cost-effective and simply constructed system for the reliable detection of unwanted hydrogen in a fuel cell system and/or in a fuel cell vehicle. Features described in connection with the detection system also apply in connection with the fuel cell vehicle according to the invention and vice versa in each case so that reference is and/or can always be made mutually with respect to the disclosure concerning the individual aspects of the invention.

In accordance with a first aspect of the present invention, a detection system for detecting hydrogen in a cavity of a fuel cell vehicle is provided. The detection system has a fuel cell system with a fuel cell housing and a purging air line for purging the fuel cell housing, and a hydrogen sensor outside the fuel cell housing. The purging air line has a purging air outlet for discharging purging air out of the fuel cell housing. The purging air outlet is designed for applying the purging air from the purging air line to the hydrogen sensor.

The arrangement according to the invention of the purging air line, or purging air opening, and of the one hydrogen sensor means that the otherwise usual hydrogen sensor within the purging air line and/or within the fuel cell housing can be dispensed with. This can reduce costs and simplify the system design of the fuel cell system. Dispensing with the hydrogen sensor and the associated functional components also creates installation space for other functional components or allows a more compact design of the fuel cell system.

The purging air outlet is preferably designed for directly applying the purging air from the purging air line to the hydrogen sensor. That is to say, the purging air outlet and/or the purging air line are designed and/or arranged in such a way that purging air escaping from the purging air line through the purging air opening can reach the hydrogen sensor directly and/or at least without obstacles.

The hydrogen sensor can be understood as a sensor unit with a sensor housing and a sensor surface in the sensor housing. A functional unit described here and arranged on the hydrogen sensor therefore does not have to be arranged directly on the sensor surface but can also be arranged on the sensor housing. The hydrogen sensor is configured and arranged to detect hydrogen and/or a hydrogen concentration in the purging air and in the cavity.

The purging air outlet is configured to discharge purging air from the fuel cell housing to the surroundings of the fuel cell housing. Depending on the design variant, the purging air outlet can be understood as an end section of the purging air line or a functional component adjoining the purging air line and connecting the purging air line to the hydrogen sensor.

The cavity can be designed to be closed or semi-closed. The cavity can be understood as an installation space, e.g., the engine installation space, in the fuel cell vehicle. The purging air line does not have to be designed in the form of an ideal duct, but can in principle have any geometry as long as it is suitable for conducting the purging air out of the fuel cell housing in a targeted manner. The fuel cell system is not purged through the purging air line but is purged by using the purging air line. The purging air line can have a purging air inlet section through which purging air is conducted into the fuel cell housing, and a purging air outlet section using which the purging air or treated purging air can be conducted out of the fuel cell housing again.

The fuel cell system preferably has a plurality of fuel cell stacks enclosed or substantially enclosed by the fuel cell housing. The hydrogen sensor can be configured in the form of a hydrogen microsensor with temperature-compensating, pressure-compensating and humidity-compensating signal analysis.

In accordance with a further design variant of the present invention, it is possible for the purging air outlet in a detection system to be directed toward the hydrogen sensor for direct application of the purging air from the purging air line to the hydrogen sensor. By orienting the purging air outlet and the purging air line directly toward the hydrogen sensor, the hydrogen concentration in the purging air can be determined particularly accurately. Mixing with other fluids can be easily prevented or at least reduced and/or adjusted to the desired amount. Orienting the purging air outlet toward the hydrogen sensor can be understood to mean that a normal vector of the purging air outlet is directed in the direction of the hydrogen sensor and/or toward the hydrogen sensor. Furthermore, a normal vector of the purging air outlet can be oriented orthogonally or at an obtuse angle to a normal vector of a sensor surface of the hydrogen sensor, wherein the normal vector of the sensor surface extends in the direction of gravity or substantially in the direction of gravity in a state installed in the fuel cell vehicle. This is a simple way of ensuring that the purging air reaches the hydrogen sensor as directly as possible.

In accordance with another design variant of the present invention, it is possible for a detection system to have a collection means for collecting hydrogen, which means is arranged at the hydrogen sensor for the purpose of conducting the collected hydrogen to the hydrogen sensor. By means of the collection means, hydrogen-containing fluid that would otherwise not be able to reach the hydrogen sensor can also be conducted to the hydrogen sensor, as a result of which the detection system can particularly effectively detect an unwanted hydrogen leakage.

With a detection system according to the invention, the collection means can be designed to be funnel-shaped. The funnel shape allows ambient air, and thus any hydrogen, to be collected and fed to the hydrogen sensor in a simple, cost-effective and yet effective manner. The funnel-shaped collection means tapers toward the hydrogen sensor. In particular, the funnel-shaped collection means tapers in the opposite direction to the direction of gravity in a state of the detection system installed in the fuel cell vehicle. The collection means is preferably designed and/or arranged coaxially and/or concentrically with the hydrogen sensor and/or the purging air outlet.

With a detection system in accordance with the present invention, the purging air outlet is preferably arranged at least partially in alignment with the hydrogen sensor. This allows the purging air flowing out of the purging air line to directly impinge on the hydrogen sensor. This allows particularly meaningful measurements to be carried out of the hydrogen content in the purging air. In this case, the purging air outlet is directed directly or substantially directly toward the hydrogen sensor. The purging air outlet being arranged at least partially in alignment with the hydrogen sensor can be understood to mean that an imaginary extension of the purging air line in the direction of a normal vector of the purging air outlet would at least partially impinge on the hydrogen sensor.

In addition, a detection system in accordance with the present invention can have a connection housing that is connected to the purging air line and the hydrogen sensor for the purpose of conducting the purging air to the hydrogen sensor. With the aid of the connection housing, the purging air and thus also the hydrogen in the purging air can be conducted directly to the hydrogen sensor without the purging air being diverted by obstacles, for example, and thus being undesirably mixed with other fluids. With the aid of the connection housing, the hydrogen sensor does not have to be arranged directly at the purging air outlet and a meaningful measurement of the hydrogen content in the purging air can still be carried out.

Furthermore, it can be advantageous if the connection housing with a detection system in accordance with the present invention is designed to be at least partially funnel-shaped. The funnel-shaped connection housing, which preferably tapers toward the purging air outlet and widens correspondingly toward the hydrogen sensor, can act as a diffuser through which the purging air flow from the purging air line can be slowed down and thus be detected more effectively at the hydrogen sensor.

Moreover, with a detection system in accordance with the present invention, it is possible for the connection housing to have at least one gas inlet opening for admitting hydrogen from the cavity into the connection housing. This is a simple and effective way of ensuring that hydrogen from the surroundings of the fuel cell housing or leakage hydrogen from the fuel cell housing can still be detected by the hydrogen sensor. The connection housing preferably has a plurality of gas inlet openings or holes for admitting hydrogen from the cavity or ambient air from the surroundings of the fuel cell housing into the connection housing. Alternatively, the connection housing can be designed to be half-shell-shaped, wherein the closed part of the connection housing connects the purging air line and the hydrogen sensor to one another and the open part of the connection housing can be understood as the at least one gas inlet opening.

Furthermore, it is possible that the purging air line of a detection system according to the invention has a nozzle and the connection housing comprises an ejector adjacent to the nozzle with a mixing chamber for providing a fluid mixture of the purging air and the hydrogen from the cavity, and with a diffuser, wherein the mixing chamber has the at least one gas inlet opening and the diffuser is connected to the hydrogen sensor for the purpose of supplying the fluid mixture to the hydrogen sensor. In this way, ambient air from the surroundings of the fuel cell housing or the leakage hydrogen contained therein can be effectively drawn into the mixing chamber and from there conducted toward or to the hydrogen sensor.

In accordance with a further aspect of the present invention, a fuel cell vehicle having a cavity and a detection system as described in detail above for detecting hydrogen in the cavity is provided. Thus, the fuel cell vehicle according to the invention offers the same advantages as have been described in detail with reference to the detection system according to the invention. The fuel cell vehicle is preferably provided in the form of a road vehicle, in particular in the form of a car or a truck.

Further measures improving the invention result from the following description of various exemplary embodiments of the invention, which are schematically illustrated in the figures. All features and/or advantages arising from the claims, the description or the figures, including structural details and spatial arrangements, can be essential to the invention both by themselves and in the various combinations.

### BRIEF DESCRIPTION OF THE DRAWINGS

The following are shown, in each case schematically:

FIG. 1 a detection system in accordance with a first embodiment of the present invention,

FIG. 2 a detection system in accordance with a second embodiment of the present invention,

FIG. 3 a detection system in accordance with a third embodiment of the present invention, and

FIG. 4 a fuel cell vehicle with a detection system in accordance with a preferred embodiment of the present invention.

Elements with the same function and mode of operation are each given the same reference signs in the figures.

### DETAILED DESCRIPTION

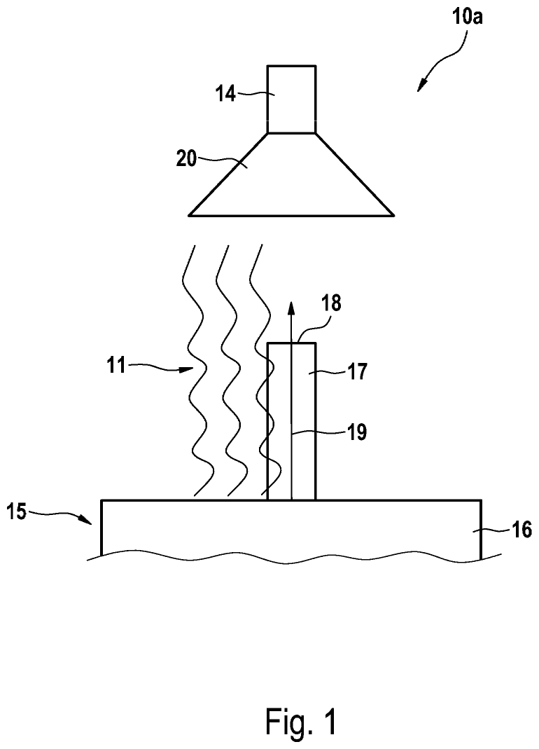

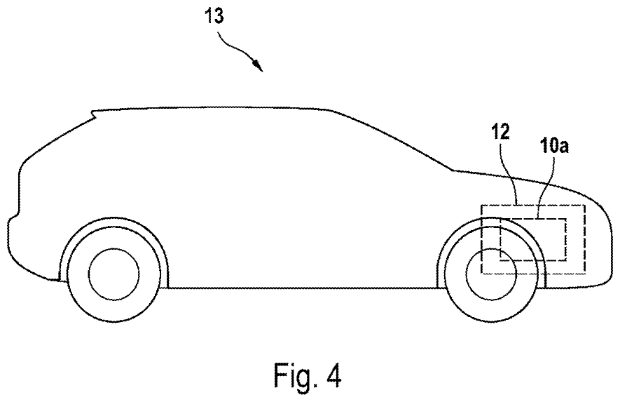

FIG. 1 shows a detection system 10a for detecting hydrogen 11 or a hydrogen content of a cavity fluid in a cavity 12 of a fuel cell vehicle 13 shown in FIG. 4, in accordance with a first embodiment. The detection system 10a has a fuel cell system 15 with a fuel cell housing 16 and a purging air line 17 for purging the fuel cell housing 16. In addition, the detection system 10a has a hydrogen sensor 14 outside the fuel cell housing 16. As shown in FIG. 1, the purging air line 17 has a purging air outlet 18 for discharging purging air 19 out of the fuel cell housing 16. The purging air outlet 18 is designed for applying purging air from the purging air line 17 to the hydrogen sensor 14. More specifically, the purging air outlet 18 is directed toward the hydrogen sensor 14 for directly application of the purging air from the purging air line 17 to the hydrogen sensor 14. As can be seen in FIG. 1, the purging air outlet 18 is arranged at a distance from the collection means 20 and from the hydrogen sensor 14 so that hydrogen 11 from the cavity 12 or hydrogen-containing fluid outside the purging air line 17 can still reach the hydrogen sensor 14 without any problems.

In accordance with the embodiment shown in FIG. 1, the detection system 10a has a collection means 20 for collecting hydrogen or ambient air from the surroundings of the fuel cell housing 16, which ambient air contains the hydrogen, if any. The collection means 20 is arranged at the hydrogen sensor 14 for the purpose of conducting the collected hydrogen or ambient air to the hydrogen sensor 14. As shown in FIG. 1, the collection means 20 is designed to be funnel-shaped, wherein the funnel shape tapers toward the hydrogen sensor 14. Furthermore, it can be seen from the illustrated embodiment that the purging air outlet 18 is arranged in alignment with the hydrogen sensor 14. An outlet opening (not shown) for discharging or removing hydrogen 11 and/or purging air 19 from the hydrogen sensor 14 is preferably formed on the hydrogen sensor 14 and/or on the collection means 20. This can prevent fluid buildup at the hydrogen sensor 14, which could lead to erroneous hydrogen detection.

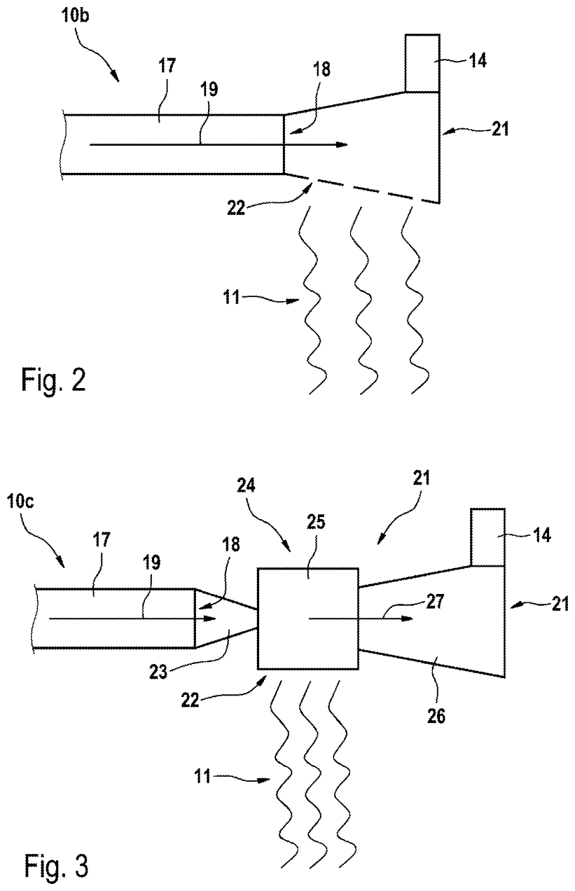

FIG. 2 shows a detection system 10b in accordance with a second embodiment. The detection system 10b shown has a connection housing 21 connected to the purging air line 17 and the hydrogen sensor 14 for the purpose of conducting the purging air 19 to the hydrogen sensor 14 and, on the right in FIG. 2, has an outlet opening for discharging the purging air 19 and the hydrogen 11 from the connection housing 21. The connection housing 21 is designed to be funnel-shaped. Furthermore, the connection housing 21 has gas inlet openings 22 for admitting hydrogen 11 or ambient air with the hydrogen contained therein from the cavity 12 into the connection housing 21. The connection housing 21 shown in FIG. 2 can in principle also be regarded as a component of the purging air line 17.

FIG. 3 shows a detection system 10c in accordance with a third embodiment. In the detection system 10c shown, the purging air line 17 has a nozzle 23. The connection housing 21 has an ejector 24 adjacent to the nozzle 23 with a mixing chamber 25 for providing a fluid mixture 27 of the purging air 19 and hydrogen 11 from the cavity 12, and a diffuser 26. Consequently, a gas inlet opening 22 is formed in the mixing chamber 25 and the diffuser 26 is connected to the hydrogen sensor 14 for the purpose of supplying the fluid mixture 27 to the hydrogen sensor 14. The ejector 24 shown in FIG. 3 can in principle also be regarded as a component of the purging air line 17. In addition or alternatively, the nozzle 23 can be considered part of the ejector 24. Like the connection housing 21 shown in FIG. 2, the connection housing 21 shown in FIG. 3 also has an outlet opening for discharging the purging air 19 and hydrogen 11 from the connection housing 21.

In FIG. 4, a fuel cell vehicle 13 is shown with a cavity 12 in the form of an engine installation space and a detection system 10a for detecting hydrogen 11 in the cavity 12, as shown in FIG. 1.

In addition to the illustrated embodiments, further design principles of the invention are possible. That is to say, the invention is not to be limited to the exemplary embodiments explained with reference to the figures. Thus, the purging air line 17 need not extend beyond the fuel cell housing 16 but can also be flush with the fuel cell housing 16.

1. A detection system (10a; 10b; 10c) for detecting hydrogen (11) in a cavity (12) of a fuel cell vehicle (13), the detection system comprising a fuel cell system (15) with a fuel cell housing (16) and a purging air line (17) for purging the fuel cell housing (16), and a hydrogen sensor (14) outside the fuel cell housing (16), wherein the purging air line (17) has a purging air outlet (18) for discharging purging air (19) out of the fuel cell housing (16),
wherein the purging air outlet (18) is configured for applying the purging air from the purging air line (17) to the hydrogen sensor (14).

2. The detection system (10a) in accordance with claim 1,
wherein the purging air outlet (18) is directed toward the hydrogen sensor (14) for direct application of the purging air from the purging air line (17) to the hydrogen sensor (14).

3. The detection system (10a) in accordance with claim 1,
wherein a collection means (20) for collecting hydrogen is arranged at the hydrogen sensor (14) for the purpose of conducting the collected hydrogen to the hydrogen sensor (14).

4. The detection system (10a) in accordance with claim 3,
wherein the collection means (20) is funnel-shaped.

5. The detection system (10a) in accordance with claim 1,
wherein the purging air outlet (18) is arranged at least partially in alignment with the hydrogen sensor (14).

6. The detection system (10b; 10c) in accordance with claim 1,
wherein a connection housing (21) is connected to the purging air line (17) and the hydrogen sensor (14) for conducting the purging air (19) to the hydrogen sensor (14).

7. The detection system (10b; 10c) in accordance with claim 6,
wherein the connection housing (21) is designed to be at least partially funnel-shaped.

8. The detection system (10b; 10c) in accordance with claim 6,
wherein the connection housing (21) has at least one gas inlet opening (22) for admitting hydrogen (11) from the cavity (12) into the connection housing (21).

9. The detection system (10c) in accordance with claim 8,
wherein the purging air line (17) has a nozzle (23) and the connection housing (21) comprises an ejector (24) adjacent to the nozzle (23) with a mixing chamber (25) for providing a fluid mixture (27) of the purging air (19) and the hydrogen (11) from the cavity (12), and a diffuser (26), wherein the mixing chamber (25) has the at least one gas inlet opening (22) and the diffuser (26) is connected to the hydrogen sensor (14) for supplying the fluid mixture (27) to the hydrogen sensor (14).

10. A fuel cell vehicle (13) with a cavity (12) and a detection system (10a; 10b; 10c) in accordance with claim 1 for detecting hydrogen (11) in the cavity (12).
